(19) United States
(12) Patent Application Publication
(10) Pub. No.: US 2008/0018598 A1
(43) Pub. Date: Jan. 24, 2008

(54) HANDS-FREE COMPUTER ACCESS FOR MEDICAL AND DENTISTRY APPLICATIONS

(76) Inventor: Randal J. Marsden, Edmonton (CA)

Correspondence Address: BLACK LOWE & GRAHAM, PLLC, 701 FIFTH AVENUE, SUITE 4800, SEATTLE, WA, 98104, US

(21) Appl. No.: 11/749,715

(22) Filed: May 16, 2007

Related U.S. Application Data
(60) Provisional application No. 60/747,392, filed on May 16, 2006.
(60) Provisional application No. 60/862,940, filed on Oct. 25, 2006.

(51) Int. Cl. G06F 3/033

(52) U.S. Cl. 345/158

(57) ABSTRACT

System and methods for a hands free mouse include a motion sensor in communication with a standard computer such that the computer receives pointer control signals from the motion sensor. The motion sensor tracks an infrared target that is attached to an instrument or a body part of a user. Therefore allowing a user to continue their task and use either their body or an instrument being used to move a pointer on a computer screen. The movement of the pointer, on the screen, correlates with the position of the pointer in space. Based on a predefined action of the infrared target by the user a click event occurs.

### PRIORITY CLAIM

This invention claims the benefit of U.S. Provisional Application No. 60/747,392 filed on May 16, 2006 and Application No. 60/862,940 filed on Oct. 25, 2006 both of which are incorporated by reference in their entirety herein.

### BACKGROUND OF THE INVENTION

The computer has become an integral part of medical and dental examination treatment processes over the past decade. Tasks that were once performed manually, such as charting, taking and viewing X-Rays, and scheduling, are now often performed on a computer in the examination and treatment rooms. This use of the computer can significantly increase productivity and efficiency.

A hands-free way to control a computer is of particular interest in the medical fields of surgery, endoscopy, radiation, dentistry, and any other areas of specialty where the doctor's hands are otherwise occupied yet they need to interact with, and control a computer. A hands-free computer access system is also particularly advantageous in environments where there is only limited support staff available.

In dentistry, there are several circumstances when the professional staff must interact with the computer while their hands are otherwise occupied. Some of these include: clinical recording, treatment planning, periodontal charting, patient education, and performing examinations (using X-Rays, intraoral camera images, and so on).

At least two problems are introduced when a computer is used in the dental or medical treatment room. The first relates to infection control. Each time the dentist, doctor, or other operator touches the computer's keyboard or mouse there is potential for the spread of bacteria and viruses, with accompanying risk of infection to the healthcare workers and patients alike. The second problem relates to the need for the operator to put down whatever tool they were holding in order to use the computer's keyboard or mouse, causing inefficiencies. Further, once the operator touches the keyboard or mouse, they must change their surgical gloves due to the risk of contamination, causing further inefficiencies.

### SUMMARY OF THE INVENTION

Systems and methods for a hands free mouse include a motion sensor in communication with a standard computer such that the computer receives pointer control signals from the motion sensor. The motion sensor tracks an infrared target that is attached to an instrument or a body part of a user. Therefore allowing a user to continue their task and use either their body or an instrument being used to move a pointer on a computer screen. The movement of the pointer, on the screen, correlates with the position of the pointer in space. Based on a predefined action of the infrared target by the user a click event occurs.

### BRIEF DESCRIPTION OF THE DRAWINGS

The preferred and alternative embodiments of the present invention are described in detail below with reference to the following drawings.

FIG. 1 shows a system for hands free operation of a computer;

FIG. 2 shows an instrument with a mounted infrared target;

FIG. 3 shows a foot pad used to create a click event in an alternate embodiment;

FIG. 4 shows an on screen keyboard; and

FIG. 5 shows a method for hands free operation of a computer.

### DETAILED DESCRIPTION OF THE PREFERRED EMBODIMENT

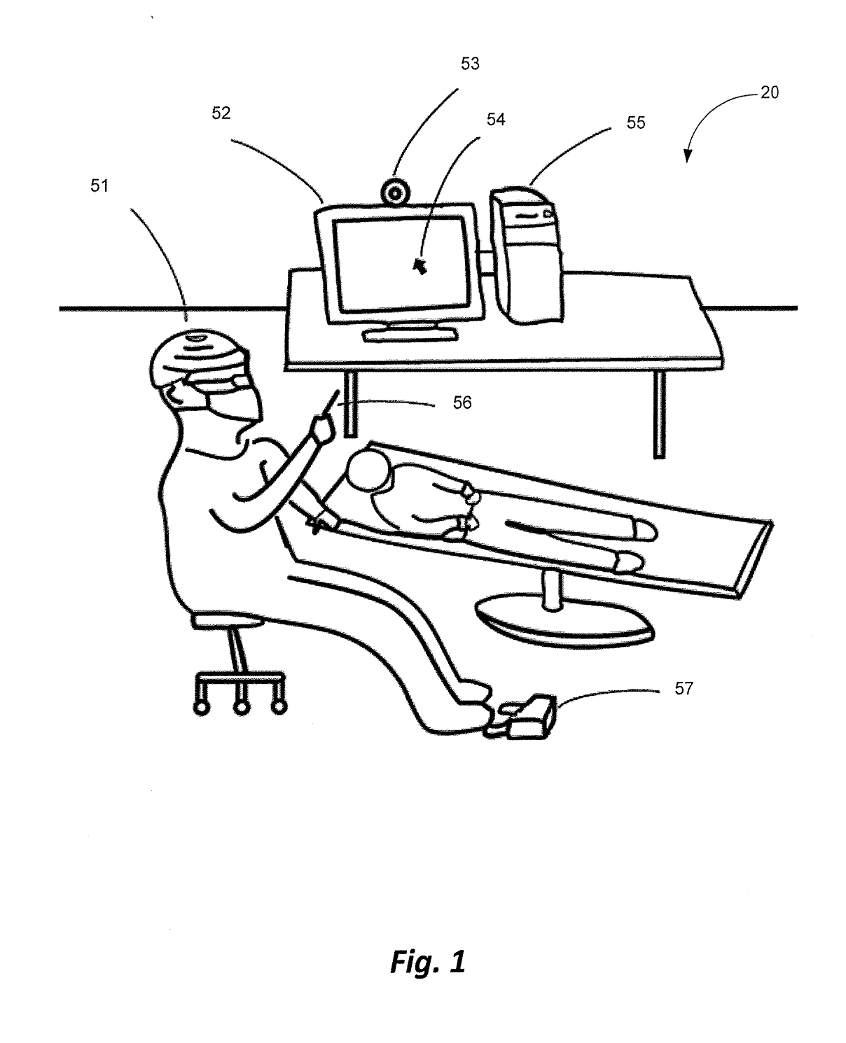

FIG. 1 shows a system 20 for hands free operation of a computer 55. The system includes, but is not limited to, a display, a keyboard, a processor, a data store capable of storing computer readable data, a storage drive, multiple input/output devices, and/or is capable of communicating on a network, an intranet, or the Internet. The computer is connected to display such that a user interface is displayed. In one embodiment a motion sensor 53 is mounted on or near a computer system 55. The motion sensor 53 is preferably mounted on a computer monitor 52. The motion sensor 53 emits infrared light. The infrared light is reflected by an infrared target mounted on an instrument 56 used by a user 51, e.g. a dentist or a medical professional. The instrument in one embodiment is a dental mirror.

The motion sensor 53 converts movement of the infrared dot on the instrument 56 into electrical signals sent to the computer 55 to control a cursor 54, that is displayed on a display, a monitor, or a screen. The instrument 56 acts similar to a mouse or other input device used in conjunction with a computer program. The motion sensor 53 sends control signals to the computer 55 to interact with a software program. The system and method are operable with any computer program, but in one embodiment interact with dental and/or medical software.

In an alternate embodiment the motion sensor 53 may be a camera. The motion sensor 53 emits infrared light or an infrared light is emitted from a source (not shown) nearby. The emitted light is reflected from the target 152 mounted on a user or the instrument 56. The motion sensor 53 tracks the movement of the infrared target in space and converts the movement into computer user interface signals. Movement can be tracked in both two dimensions and in three dimensions.

X and Y axes are defined as the horizontal and vertical axes of a plane of an image captured by the sensor 53 (perpendicular to the line-of-sight). The Z axis is defined as the horizontal axis of a plane that is parallel to the line-of-sight of the sensor 53.

A sensed movement of the target 152 generally vertical and parallel to the display 54, the computer 55 would move a cursor 54 in the same direction on the display 54. The Z axis is defined by the distance between the sensor 53 and the instrument 56. To calculate movement on the Z axis the sensor 53 and/or computer 55 analyzes the change in size of the infrared target on the instrument 56.

The computer 55 is programmed to determine various characteristics of the target from the images generated by the sensor 53. For example, when the computer 55 senses motion and/or speed in any of the X, Y, or Z axes, the detected motion and/or speed is used to provide controlling motions for the displayed cursor 54 or is associated with any of a number of stored gesture motions. The computer 55 associates one or more user interface actions with each of the gesture motions. For example user interface actions include Save, Delete, Highlight, Select (click event), or any other action that is associated with the present application program that the computer 55 is running.

In an alternate embodiment, the user 51 actuates one or more external switches 57 with a foot or other part of the body to perform a selection on the computer 55. The switches 57 connect to motion sensor 53 where their signal is converted to mouse button signals, and then sent to the computer 55. Further still the connection between the switches 57 to the motion sensor 53 may be a wired or a wireless connection. In an alternate embodiment the switches 57 are connected to the computer 55 wither by a wired or wireless connection.

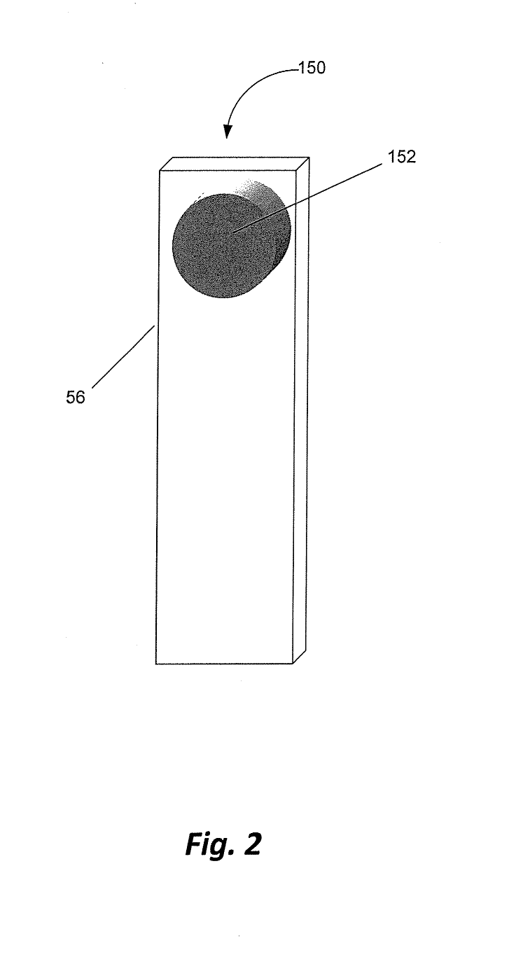

FIG. 2 shows an embodiment of the instrument 56 with a mounted infrared target 152. The instrument 56 can be any structure in which the infrared target 152 may be mounted. The infrared target 152 has the capability to reflect infrared light back to a motion sensor. For example the reflection of light allows for the motion sensor to identify the location of the target 152, by searching the viewing area for an infrared reflection.

In an alternate embodiment, the motion sensor 204 tracks movement in its field of view without the use of an infrared target. This is accomplished through the use of sensors (e.g. a mechanical systems device, such as accelerometers, or gyros) on a user or the instrument 56 that transmit movement coordinates to the motion sensor.

In yet another embodiment the motion sensor is an external apparatus that processes and generates signals that are similar to a computer pointer. These signals are transmitted to a computer through and input device, such as a USB port, and are recognized by a computer as pointer commands.

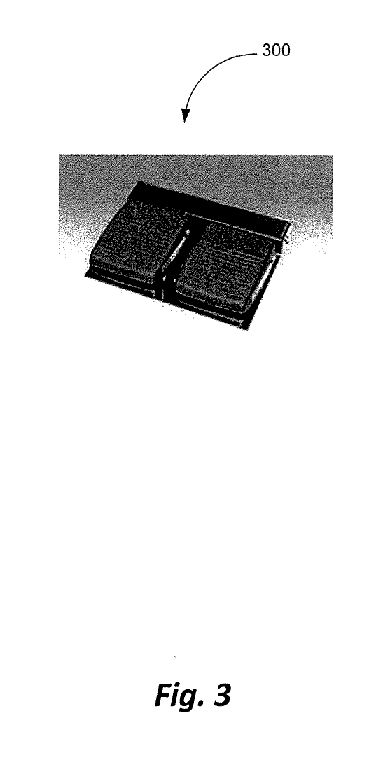

FIG. 3 shows a foot pad input device 300 used to create a click event in an alternate embodiment. The foot pad 300 performs the same function as a typical left and right mouse button, allowing a user to right and left click, as well as double click. The pad 300 may be in wireless or wired communication with the computer 55. In an alternate embodiment a click (selection of a button or feature in an application program presented on the display 52). In an alternate embodiment a click by may occur using a sip/puff switch, a blink, a voice command as recognized by voice activation software, and/or check switches in communication with the sensor 53 or computer 55. In yet another alternate embodiment, software may be used to execute a click, when a user pauses on a clickable field.

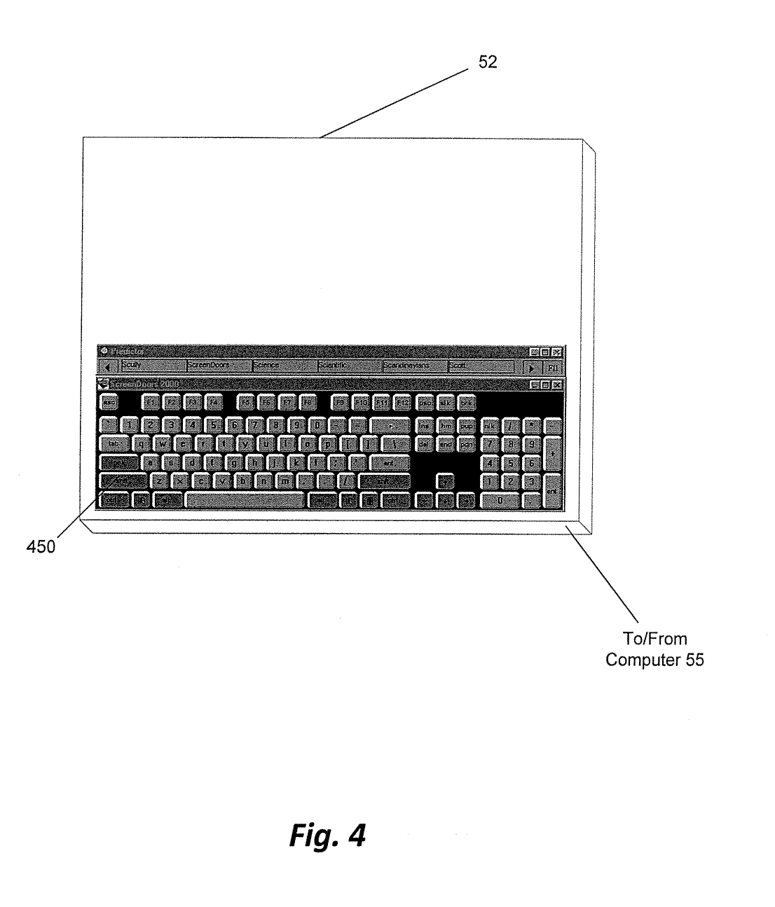

FIG. 4 shows an on screen keyboard 450. In one embodiment software is provided to install an on screen keyboard onto a user interface. The keyboard being configured to have a user, using the instrument 56 with an infrared target, type on the screen. The letter is typed when the cursor 54 is over a desired key on the keyboard 450 and when the user performs a click event. The system and method also having the capability to predict what text is being entered. The software further allows for preprogrammed abbreviations to be entered that allow a user to enter an abbreviation. The software then expands that abbreviation into the full word.

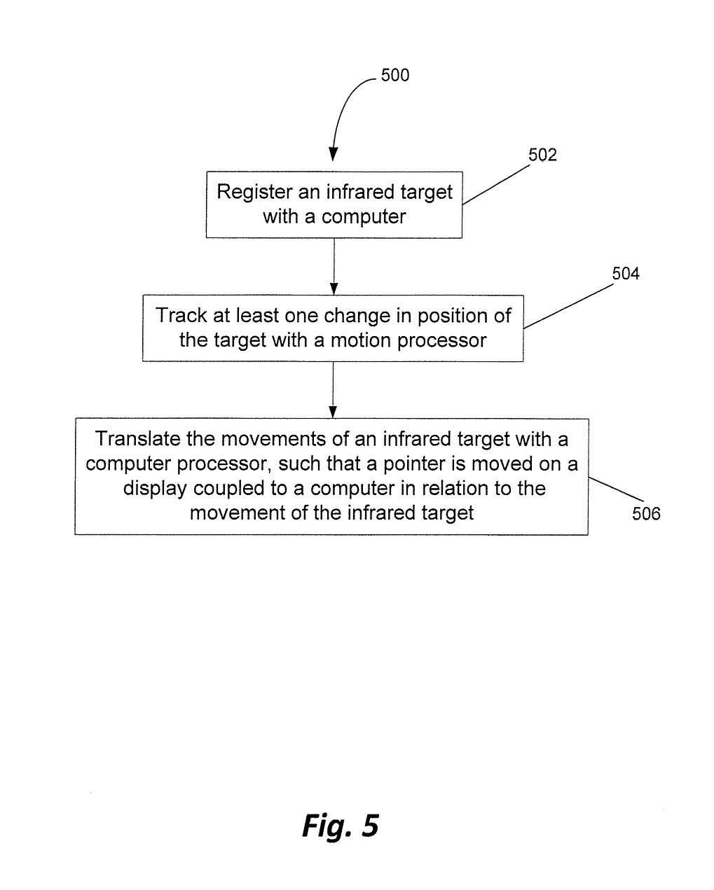

FIG. 5 shows a method 500 for hands free operation of the computer 55. At block 502 the motion sensor registers an infrared target with a processor on a computer. The target is identified as the item to be tracked on an instrument within the field of view of the motion sensor. At block 504 at least one movement of the instrument is tracked with the motion sensor. The motion sensor tracks the movement of the instrument in both two and three dimensions. At block 506 the movements of an infrared target are translated into code to be executed by a computer processor. The motion sensor translates movement on the X or Y axis into computer signals moving the pointer along the same axis on the user interface. In a three dimensional environment the movement of the instrument along the Z axis results in a click event. In a two dimensional model speed and/or action results in a click event. For example a short downward burst may result in a left click. The motion sensor is constantly tracking the movement of the infrared target and updates the pointer on the display accordingly.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A system for controlling a pointing device in a three dimensional plane comprising:
an instrument;
a target device attached to the instrument;
a camera capable of capturing two or more images in a field of view comprising a target and an instrument;
a display; and
a processor in signal communication with the display and the camera configured to determine motion of the target based on the received images and performing at least one of controlling a cursor on the display or executing an activation event based on the determined motion of the target.

2. The system of claim 1, wherein the processor determines motion of the target in at least one of the plane perpendicular to the display or the plane parallel to the display.

3. The system of claim 2, further comprising:
a user interface on the display having an on screen keyboard wherein a user using the instrument enters text.

4. The system of claim 3, further comprising:
a foot controller in communication with the computer.

5. The system of claim 4, wherein the computer contains software that monitors text input and predicts commonly used words.

6. The system of claim 5, wherein the sensed movements control operations in a Windows based user interface.

7. The system of claim 6, wherein the software contains common medical terms.

8. The system of claim 7, wherein the target is an infrared target.

9. The system of claim 7, wherein the instrument is a medical instrument.

10. The system of claim 9, wherein the system is a dental system.

11. The system of claim 10, wherein the medical instrument is a dental mirror.

12. A method for controlling a pointing device comprising:
registering an infrared target with a computer;
determining the movements of an infrared target with a motion sensor; and
controlling a cursor based on the tracked movements of an infrared target with a computer processor, the cursor being displayed on a user interface generated by an application program.

13. The method of claim 12 further comprising:
tracking a movement at least one of movement perpendicular to the display or parallel to the display; and
initiating a click event on the computer.

14. The method of claim 13 further comprising:
operating a keyboard displayed on a user interface based at least one of the tracked movement.

15. The method of claim 14 wherein the computer executes software to predict words based on text input.

16. The method of claim 15, wherein the target is attached to a user's forehead.

17. The method of claim 15, wherein the instrument is a medical instrument.

18. The method of claim 17, wherein the system is a dental system.

19. The method of claim 18, wherein the medical instrument is a dental mirror.

20. The method of claim 19, wherein the dental mirror is used in conjunction with a software application for dentistry.
